(19) United States
(12) Patent Application Publication
(10) Pub. No.: US 2004/0016727 A1
(43) Pub. Date: Jan. 29, 2004

(54) Laser beam welding system and process for laser beam welding

(76) Inventors: Stefan Hierl, Berg (DE); Peter Hluchy, Uttenreuth (DE); Kai Lenfert, Buckenhof (DE); Gunter Kuechler, Haselau (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/258,816

(22) PCT Filed: Mar. 2, 2001
(86) PCT No.: PCT/EP01/02350

(30) Foreign Application Priority Data
Apr. 28, 2000 (DE) 100208207

(51) Int. Cl. B23K 26/20

(52) U.S. Cl. 219/121.63; 219/121.64

(57) ABSTRACT

A laser beam welding system has a contact pressure device for fixing components to be welded. The contact pressure device contains a contact pressure element which can be moved from an inoperative position into a contact pressure position. The contact pressure element is constructed to be elastically deformable, and the contact pressure device is designed such that, in the contact pressure position, fixing of the components to be welded takes place by way of a force resulting from deformation of the contact pressure element. In addition, at least one device is provided for increasing the thermal energy absorbed by the components by way of an at least partial absorption of the laser beam.

The present invention relates to a laser beam welding system having a contact pressure device for fixing the components to be welded, the contact pressure device containing a contact pressure element which can be moved from an inoperative position into a contact pressure position. In addition, the invention relates to a process for the laser beam welding of components, a contact pressure element of a contact pressure device, for fixing the components to be welded, being moved from an inoperative position into a contact pressure position.

Such arrangements or processes are known from the prior art from European Patent Document EP 0 687 519 A1 and from U.S. Patent Document U.S. Pat. No. 4,847,467. In this case, one massive contact pressure element respectively is pressed onto the components to be welded together, whereby the components are held together and partially deformed. However, such arrangements or processes have the disadvantage that the components to be welded together may be damaged, particularly when especially sensitive components are to be welded together.

From Japanese Patent Document JP 5-77 071 A, a laser beam welding system having a contact pressure device for fixing the components to be welded is known, in the case of which the contact pressure device contains a contact pressure element which can be moved from an inoperative position into a contact pressure position, the contact pressure element being constructed to be elastically deformable, and the contact pressure device being designed such that, in the contact pressure position, a fixing of the components to be welded takes place by a force resulting from a deformation of the contact pressure element.

U.S. Pat. No. 4,978,835 describes a process for positioning contacts by means of a glass plate or a membrane in order to permit a subsequent welding-together of the contacts by means of a laser beam. In this case, either the membrane or a coating of the membrane can additionally absorb a portion of the laser radiation in order to thereby promote the welding-together of the contacts. It is possible that, during this operation, the material of the membrane is decomposed during the process. It is a disadvantage of this process that the membrane serving as a hold-down device directly covers the contacts to be welded together and may thereby cause disturbing influences on the welding operation and possible considerable contamination of the welds.

German Patent Document DE 195 16 726 describes a process for welding together folding boxes, in which a pressure roller presses together the parts to be welded together after the irradiation by means of a laser. The pressure roller may also be reflecting so that a portion of the radiation reflected by the weld is reflected back onto the weld. However, here it is particularly disadvantageous that, as a result of the shape of the pressure roller, the largest portion of the reflected laser radiation is scattered away from the weld and thus no significant increase of the welding capacity can be achieved.

Thus, none of these known teachings from the prior art provides a possibility of implementing a secure and effective welding-together of components which have only a slight absorption degree for the wavelength ranges of conventional material processing lasers. Because of a lack of sufficient absorption, a sufficient temperature for implementing a welding can be generated in the components to be welded together only when a correspondingly high laser power is selected, in which case it is difficult to apportion the feeding of energy and thermal damage can therefore be caused.

It is therefore an object of the present invention to provide an improved arrangement and an improved process for laser beam welding which can be used particularly for components with a low degree of absorption of the corresponding laser radiation.

This object is achieved by means of the characteristics of claims 1, 7, 9 and 17.

In the case of the laser beam welding system according to the invention, in each case, the contact pressure element has an elastically deformable construction, and the contact pressure device is designed such that, in the contact pressure position, a fixing takes place of the components to be welded as a result of a force originating from a deformation of the contact pressure element. Thus, no longer is a rigid massive contact pressure element provided as in the prior art, which is the main cause for damage to the components. Because of the flexibility of the contact pressure element, which is a result of its elastic deformability, a fixing of the components can be achieved which is as careful as possible with respect to the material. According to the invention, it is further provided that at least one device is present for increasing the thermal energy absorbed by the components on the basis of an at least partial absorption of the laser beam. The at least one device provides that additional radiation from the laser beam is absorbed and the corresponding directly or indirectly created thermal energy is fed to the components in order to achieve a welding-together of the components because of a heating which occurs there. The at least one device can either, instead of the components, absorb additional fractions of the radiation of the laser beam or, instead of the components, provide components which absorb certain fractions of the radiation. However, the device can also increase the absorption of the radiation of the laser beam in the components themselves, for example, by an appropriate influencing of the radiation of the laser beam.

The degree of absorption achieved by the device does not have to extend to a complete absorption of the laser radiation. It is basically sufficient that, by means of the device, sufficient additional thermal energy is fed to the components, which results from an absorption of radiation fractions of the laser radiation, so that the components can be welded together.

In a first case, in which the at least one device contributes to the radiation absorption as a replacement for the components, it is provided that the at least one device, at least in the contact pressure position, projects at least partially into the beam path of the laser beam and is constructed such that an at least partial absorption of the laser beam takes place by means of the at least one device or by means of sequential products of the at least one device. Thus, the device can either be maintained unchanged under the influences of the laser radiation and can contribute to the increase of the radiation absorption as a result of the higher degree of absorption by the device itself. Or there may be an at least partial chemical or physical conversion of the device, either the conversion being initiated by the absorption of radiation fractions of the laser radiation and the conversion itself supplying additional thermal energy, or the sequential products arising from the conversion contributing to the absorption of the laser radiation and, as a result, additional thermal energy being supplied. For reasons of simplicity, in the following, reference is made as a rule to an absorbing material, which basically means that either the material itself, its conversion or its sequential products contribute to the absorption.

The at least one device can be formed, for example, by a partial area of the contact pressure element. In particular, the contact pressure element may consist in the partial area of a material absorbing the laser beam and therefore have an absorbing effect over its entire dimension in this partial area. However, it may also be provided that, in this partial area, the contact pressure element has a coating absorbing the laser beam. In this case, the contact pressure element does not have to have the absorbing effect in its remaining dimension in this partial area.

However, the at least one device may also be formed by a component which is independent of the contact pressure element, particularly by an absorption device made of a material absorbing the laser beam, which absorption device is arranged at least in the contact pressure position between the contact pressure element and the components.

In the event that no conversion of the at least one device takes place, a temperature-stable material, particularly a metallic or ceramic material, may be provided as the material. In the case of a conversion of the material, as mentioned above, a material may be provided which, when irradiated by the laser beam, experiences a chemical or physical conversion, such as an oxidation, which releases thermal energy. Finally, a material may be provided which, when irradiated by the laser beam, experiences a chemical or physical conversion (for example, an oxidation, evaporation or similar process), in which case the degree of absorption is increased because of the conversion, particularly because of the fact that the forming products are constructed such that they absorb the laser beam.

An alternative object has the result that the absorption in the components themselves, which are to be welded together, is increased. For this purpose, particularly the at least one device, at least in the contact pressure position, can act at least partially as a beam trap for the laser beam and may be constructed such that, as the result of the at least one device, an at least partial return reflection onto the components takes place of the laser radiation of the laser beam reflected by the components. The radiation reflected particularly by poorly absorbing components is thereby again directed onto the components and the efficiency is therefore increased without requiring, for example, a stronger radiation source. The beam trap can be formed, for example, by a suitable geometrical construction of the contact pressure element. However, separate devices forming a beam trap may also be provided on the contact pressure element.

In principle, the contact pressure element can be arranged on the contact pressure device in any possible manner in order to ensure a fixing of the components to be welded together relative to the laser beam welding system. However, preferably the contact pressure element is arranged as close as possible to the beam path of the laser beam, ideally directly in the beam path of the laser beam. In the latter case, the contact pressure element has an opening which is constructed such that an at least partial passing of the laser beam through the contact pressure element is possible in the direction of the components to be welded, at least in the contact pressure position. Because of the flexibility of the contact pressure element, the opening must therefore not be arranged in every position, that is, for example, not necessarily also in the inoperative position, in the beam path of the laser beam. It is only required that, after the pressing-on of the components, that is, after the deformation of the contact pressure element, the opening is arranged in the beam path of the laser beam. An arrangement of the contact pressure element in the beam path of the laser beam is particularly advantageous because, as a result, a fixing of the components to be welded can take place directly in the area of the weld.

The elastically deformable contact pressure element may be formed of any suitable material having sufficient flexibility. For example, corresponding plastic materials are conceivable in this case. However, the marginal conditions existing during the welding operation should be observed, particularly with respect to the temperature stability of the contact pressure element. The contact pressure element is therefore preferably constructed as a spring element made of metal, particularly as a formed metal strip. Such a metal strip is to be connected at least at one end with the contact pressure device. In order to have a sufficient elastic deformability or spring effect, the metal strip may be preformed to be bent or may be bent by being mounted on the contact pressure device. Thus, the metal strip can, for example, either be prebent in a semicircular shape or a straight metal strip may be fastened at both ends to the contact pressure device while being deflected.

In any case, a material should be selected for the contact pressure element in the case of which, if possible, no adhesion occurs on the components to be welded together. If the contact pressure element is constructed, for example, as a spring element made of metal, tungsten, Cr—Ni steel or spring band steel is preferably selected as the material of the contact pressure element.

For a monitoring of the welding operation which is as precise as possible, a pyrometer may be provided which is used for detecting the heat radiation emitted by the weld. The pyrometer should therefore be arranged such that the heat radiation emitted by the weld reaches the pyrometer directly or by corresponding deflection devices. For this purpose, it may, for example, be provided that a dichroitic beam divider is arranged in the beam path of the laser beam, which is constructed such that the heat radiation emitted by the weld is directed by the beam divider to the pyrometer. As a result, on the one hand, the already existing lens system for focussing the laser beam can also be utilized for the detection of the heat radiation and the pyrometer does not have to be arranged in a direct line of sight to the weld, but may be mounted at a suitable point at the laser beam welding system.

In the case of the process according to the invention for laser beam welding of components, in which a contact pressure element of a contact pressure device, for fixing the components to be welded together, is moved from an inoperative position into a contact pressure position, it is provided that

an elastically deformable contact pressure element is connected such with the contact pressure device that it is arranged in the beam path of the laser beam,

the contact pressure element is moved into the contact pressure position and is held at a defined contact pressure in the contact pressure position,

in the contact pressure position, an opening is placed in the contact pressure element by means of the laser beam,

adjacent to the components, at least one device is arranged for increasing the thermal energy absorbed by the components, on the basis of an at least partial absorption of the laser beam; and

during the welding operation, the contact pressure element is held at the same defined contact pressure for fixing the components in the contact pressure position.

It is therefore provided that, by means of the laser beam, an opening is placed in the contact pressure element after the contact pressure element had been moved into the contact pressure position, or that, at the start of the process, an opening is placed in the contact pressure element in a mechanical or different manner. As a result of this process according to the invention, a laser beam welding system is provided in a particularly simple manner with a flexible contact pressure element and a laser beam welding of components is carried out, in which case, on the one hand, as a result of the elastic deformability of the contact pressure element, damage to the components is avoided and, on the other hand, when the opening is made by means of the laser beam, a high-expenditure adjusting of the device can be eliminated in that the opening in the contact pressure element is made in a self-adjusted manner under the conditions existing in the contact pressure position. It is therefore ensured that, in the contact pressure position, the opening is automatically situated in the beam path of the laser beam. By providing the at least one device for increasing the thermal energy absorbed by the components adjacent to the components to be welded together, it is ensured, even in the case of an only slight absorption of the laser radiation by the components themselves, sufficient thermal energy is fed to the components. In this case, the device is to be arranged adjacent to the components in such a manner that a sufficient thermal coupling exists between the device and the components in order to reach the welding temperature at the components.

In order to, in addition, be able to carry out an adjustment of the welding parameters which is as precise as possible during the welding operation for the purpose of, for example, setting the welding temperature as exactly as possible and being able to hold it constant, it may be provided

that, during the welding operation, a detection of the thermal radiation of the weld takes place, and

as a function thereof, a controlling of the power of the laser beam takes place.

Such a detection of the thermal radiation can take place, for example, by means of a pyrometer, as indicated above.

Particularly advantageously, the detection of the thermal radiation can take place coaxially to the beam path of the laser beam. As indicated above, the lens system used for the focussing of the laser beam can be correspondingly utilized for this purpose.

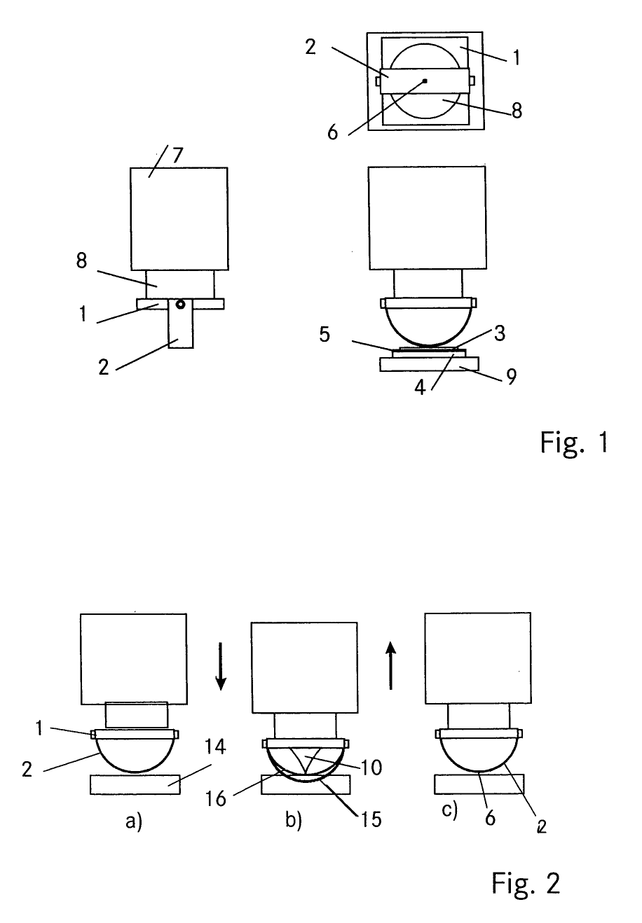

A special embodiment of the present invention will be explained in the following by means of FIGS. 1 to 4.

FIG. 1 is a schematic view of the construction of the laser beam welding system with the contact pressure device;

FIG. 2 is a view of the self-adjusted placing of the opening into the contact pressure element;

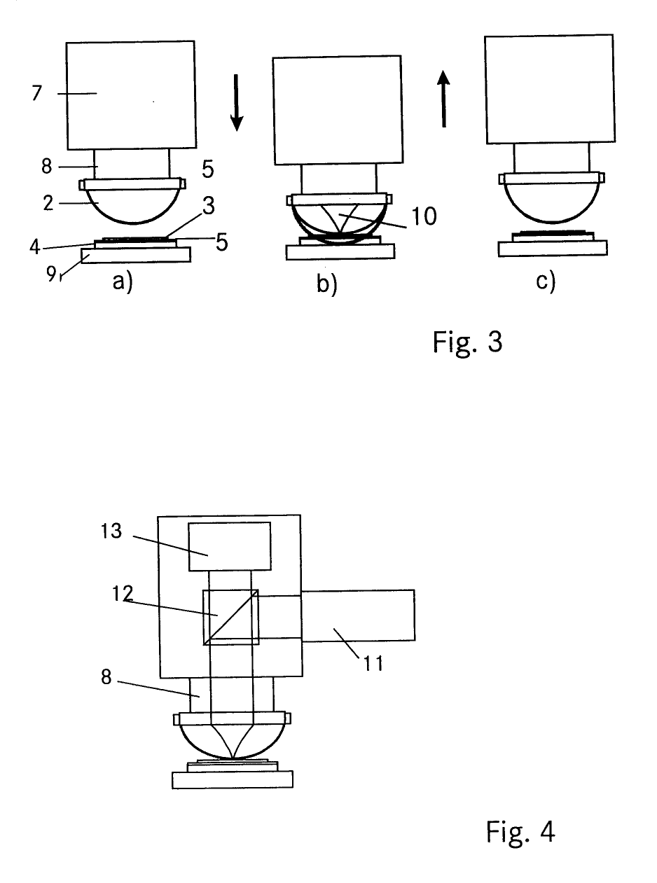

FIG. 3 is a schematic representation of the process steps during the laser beam welding of components;

FIG. 4 is a schematic representation of the laser beam welding system with the pyrometer;

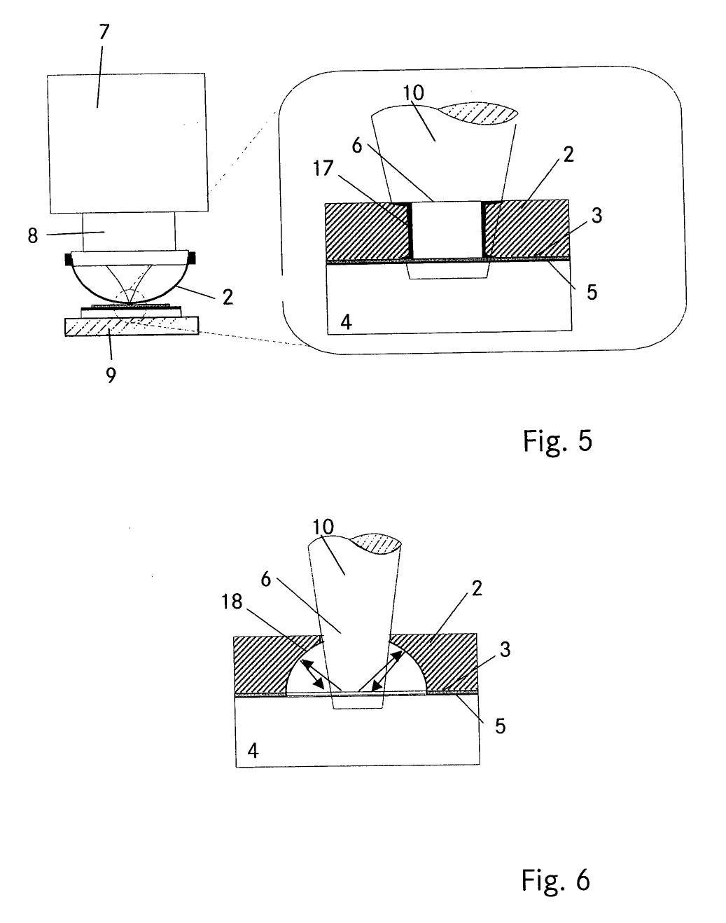

FIG. 5 is a detailed representation of a device for increasing the thermal energy absorbed by the components, as a partial arrangement of the contact pressure element in the beam path of the laser beam;

FIG. 6 is a detailed representation of a device for increasing the thermal energy absorbed by the components, as a construction of the contact pressure element as a beam trap;

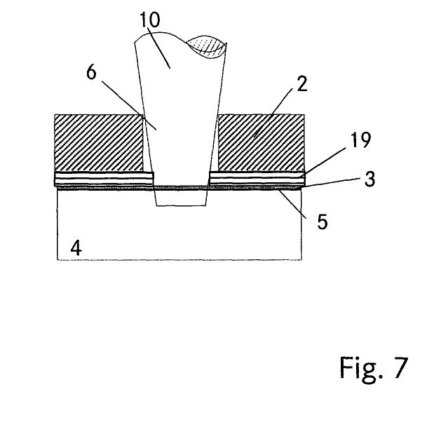

FIG. 7 is a detailed representation of a device for increasing the thermal energy absorbed by the components, as a separate absorption device.

For overlap-joint laser beam welding, as, for example, for welding thin metal foils 3 of a thickness in the μm-range, particularly of a thickness of less than 50 μm, onto another metal foil 4 or onto a substrate 4 having a metallization 5, laser beam thermal conduction welding is used. A high-power diode laser is used as the beam source 13, which emits laser radiation of a wavelength of λ=790 nm to 980 nm. However, for example, an Nd:YAG-laser (which may also be frequency-converted) or a CO2-laser can also be used.

For establishing a good thermal contact between the components 3, 4, the metal foil 3 is pressed by means of a special contact pressure element or hold-down device 2 during the welding process onto the component 4 situated underneath. In addition, the latter may be fixed on a support 9. The hold-down device 2 consists essentially of an elastically deformable metal strip, which is part of a contact pressure device 1. The latter may be fastened directly to the focussing lens system 8 or to the housing 7 of the diode laser 13. For this purpose, the metal strip 2 is bent in a semicircular shape or is already shaped in a semicircular bent manner and, as illustrated in FIG. 1, is laterally fixed to a contact pressure device 1 situated on the focussing lens system 8. The hold-down device 2 is therefore situated in the beam path of the laser beam 10.

For preparing the hold-down device 2 for the welding process, a bore 6 is placed, either at the start of the process mechanically or during the process in the contact pressure position by means of the diode laser 7, for example, by individual laser pulses, in the metal strip 2, through which bore 6, during the later welding of the components 3, 4, the laser radiation impinges on the upper component 3. When producing the bore in the hold-down device 2, the latter, as illustrated in FIG. 2, is moved from an inoperative position a) into a contact pressure position b) and, in the process, is placed on a flat plate 14, until, as a result of an elastic deformation, the hold-down device 2 assumes the same shape as achieved during the actual welding process. The hold-down device 2 is therefore brought from an inoperative form 15 into an elastically deformed shape 16. The bore 6 will then be made in the hold-down device by means of the laser beam 10. The thus generated bore 6 has, for example, a diameter in the range of tenths of millimeters.

By placing the bore 6 in the hold-down device 2 in this manner, it is ensured that the position and the shape of the bore 6 coincides precisely with the position and shape of the beam caustic of the used diode laser 13. As a result, it is ensured that, during the entire welding process, a good thermal contact exists of the components 3, 4. An adjusting of the hold-down device 2 relative to the laser beam 10 is therefore not required.

A metal is used as the material for the hold-down device 2, in the case of which no adhesion occurs of the components to be welded together, as for example, of the metal foil 3 with the hold-down device 2. Suitable materials are, for example, tungsten, Cr—Ni steel or spring band steel.

Before the welding, the components 3, 4 are brought into their final position, as illustrated in FIG. 3. In this case, they may be arranged on a support 9. The entire arrangement and thus the diode laser 13 and the contact pressure device 1 with the hold-down device 2 are lowered from an inoperative position a) into a contact pressure position b) onto the components 3,4, until the hold-down device 2 touches the metal foil 3 situated on top and is elastically deformed by the further lowering of the arrangement with the contact pressure device 1. Typical moving speeds for the lowering of the arrangement are within the range of several mm/s to several hundred mm/s.

By means of the elastic deformation of the hold-down device 2, the contact pressure required for the welding process is generated. The selection of the radius as well as the width and thickness of the metal strip for the hold-down device 2 determine the desired contact pressure in the case of the desired distance of the focussing lens system 8 from the metal foil 3. For example, metal strips are used which have a thickness of several tenths of millimeters and a width of several millimeters to several centimeters. The radius of the mounted hold-down device 2 will then preferably be in the range of several centimeters.

The geometry of the hold-down device-metal strip and the fact that the bore 6 in the hold-down device 2 coincides precisely with respect to the position and shape of the caustic of the laser beam 10 permit, even at a contact pressure force of a few newtons, an optimal thermal contact of the components 3, 4.

After the pressing of the metal foil 3 onto the component 4 situated underneath, these are welded together by means of a laser pulse. In this case, the laser beam 10 impinges through the bore 6 in the hold-down device 2 onto the upper component 3 and melts it open. As a result of thermal conduction, the component situated underneath, such as a metal foil 4 or a metallization 5 of a substrate 4, is also melted open. The molten masses mix with one another and a durable welded connection takes place. The process parameters laser power, focus position and pulse duration are adjusted such that, when the welded connection is optimal, damage to the components is avoided. Typical process times for the welding of silver foil of a thickness in the pm-range on Si substrate with a metallization thickness also in the pm range are in the range of tenths of milliseconds to seconds, particularly at 10 to 500 milliseconds at a laser power in the range of 10 to 500 W. After the laser pulse, the arrangement with the diode laser 13 and the hold-down device 2 is lifted from the workpiece 3, 4 back into the inoperative position c), and the arrangement is moved over the next weld.

In certain cases, for example, during strong fluctuations of the absorption of the laser radiation, the implementation of a temperature control is required. This temperature control is implemented in that, by means of a pyrometer 11, the thermal radiation emitted by the weld is detected (FIG. 4). During the welding process, the pyrometer signal is used for controlling the laser power such that a desired temperature course is reached for the duration of the process.

The used pyrometer 11 preferably operates in a spectral range of wavelengths in the um-range and preferably has a measuring range to approximately 2,000° C., particularly of approximately 700° C. to 2,000° C. Since the bore 6 in the hold-down device 2, through which the thermal radiation is emitted upward from the weld, has a very small diameter, thermal radiation directly from the weld can be detected only at a small solid angle. The thermal radiation is therefore absorbed coaxially to the laser radiation 10. For this purpose, a dichroitic beam splitter 12 is integrated in the beam path of the diode laser 13, which beam splitter 12 deflects the thermal radiation emitted by the weld and collimated by the focussing lens system 8 of the diode laser 13 by 90° into the pyrometer 11.

When now components 3, 4 are to be welded together by means of the described arrangement, which have only a low degree of absorption for the laser radiation, additional devices 17, 18, 19 can be provided for increasing the thermal energy absorbed by the components 3, 4, this increase being based on an at least partial absorption of the laser beam. For this purpose, reference is made to the examples of FIGS. 5 to 7.

In the example according to FIG. 5, a partial area 17 of the contact pressure element 2 in the contact pressure position projects into the beam path of the laser beam 10. However, as illustrated in FIG. 7, it may be provided as an alternative that an absorption device 19, which is separate from the contact pressure device 2, in the contact pressure position, projects into the beam path of the laser beam 10, in which then ideally the absorption device 19 in the contact pressure position is arranged between the contact pressure element 2 and the components 3, 4, so that a fitting mutual fixing of the individual elements can take place at the contact pressure of the contact pressure element 2. The elements 17, 19 projecting into the beam path of the laser beam 10 now make an additional contribution to the absorption of the radiation of the laser beam 10. In the areas which project into the beam path, the elements 17, 19 may consist either of a temperature-stable, for example, metallic or ceramic material, such as CrNi steel, which ensures a sufficient absorption of the laser radiation, or in these areas, the elements may have a corresponding coating, such as graphite. The material of the elements 17, 19 or their coating, however, may also experience a chemical or physical conversion under laser radiation 10. In this case, either as a result of the conversion itself, as for example, by an oxidation or other combustion, for example, of carbon, initiated by an absorption of the laser radiation 10, additional thermal energy is created, or the conversion increases the degree of absorption of the device 17, 19 or of the components 3, 4, and thereby contributes to an improved overall absorption. In particular, the sequential products, occurring during the conversion, such as oxides, plasmas, molten masses or deposits of burn-up products on the components 3, 4, can contribute to an increase of the absorption of the laser radiation 10 and thus to the thermal energy fed to the components 3, 4.

However, the laser radiation 10 itself may also be influenced in order to achieve an increased absorption in the components 3, 4. For this purpose, as, for example, illustrated in FIG. 6, the laser radiation reflected by the components 3, 4 can be reflected back onto the components 3, 4, in this case, by means of a beam trap 18. For this purpose, FIG. 6 shows a possibility in which the beam trap 18 is formed by a suitable geometrical construction of the contact pressure element 2 or of the area around the opening 6 in the contact pressure element 2.

In FIG. 6, this area acts like a concave mirror which reflects the reflected radiation in a concentrated manner back onto the components 3, 4. However, the beam trap may also be formed by means of other suitable devices in or on the contact pressure element 2 or independently of the contact pressure element 2.

1. Laser beam welding system having a contact pressure device (1) for fixing the components (3, 4) to be welded, the contact pressure device (1) containing a contact pressure element (2) which can be moved from an inoperative position into a contact pressure position, the contact pressure element (2) being constructed to be elastically deformable and the contact pressure device (1) being designed such that, in the contact pressure position, a fixing takes place of the components (3, 4) to be welded by means of a force resulting from a deformation of the contact pressure element (2), furthermore, at least one device (17, 18, 19) being provided for increasing the thermal energy absorbed by the components (3, 4), on the basis of an at least partial absorption of the laser beam (10), the at least one device (17, 18, 19), at least in the contact pressure position, projecting at least partially into the beam path of the laser beam (10),
characterized in that the at least one device (17, 18, 19) is constructed such that, as a result of the laser beam (10), an at least partial chemical or physical conversion of the at least one device (17, 18, 19) takes place, the sequential products of the conversion being constructed such that additional thermal energy is supplied by an absorption of laser radiation by the sequential products.

2. Laser beam welding system according to claim 1,
characterized in that the at least one device (17, 18, 19) is formed by a partial area (17) of the contact pressure element (2).

3. Laser beam welding system according to claim 2,
characterized in that the contact pressure element (2) in the partial area (17) consists of a material absorbing the laser beam (10).

4. Laser beam welding system according to claim 2,
characterized in that the contact pressure element in the partial area (17) has a coating absorbing the laser beam (10).

5. Laser beam welding system according to claim 1,
characterized in that the at least one device (17, 18, 19) is formed by an absorption device (19) made of a material absorbing the laser beam (10) and arranged at least in the contact pressure position between the contact pressure element (2) and the components (3, 4).

6. Laser beam welding system according to one of claims 1 to 5,
characterized in that the contact pressure element (2) is arranged in the beam path of the laser beam (10) and has an opening (6) which is constructed such that an at least partial passing of the laser beam (10) through the contact pressure element (2) is possible in the direction of the components (3, 4) to be welded, at least in the contact pressure position.

7. Laser beam welding system having a contact pressure device (1) for fixing the components (3, 4) to be welded, the contact pressure device (1) containing a contact pressure element (2) which can be moved from an inoperative position into a contact pressure position, the contact pressure element (2) being constructed to be elastically deformable and the contact pressure device (1) being designed such that, in the contact pressure position, a fixing takes place of the components (3, 4) to be welded by means of a force resulting from a deformation of the contact pressure element (2), furthermore, at least one device (17, 18, 19) being provided for increasing the thermal energy absorbed by the components (3, 4), on the basis of an at least partial absorption of the laser beam (10), the at least one device (17, 18, 19), at least in the contact pressure position, projecting at least partially into the beam path of the laser beam (10), the at least one device (17, 18, 19) being constructed as part of the contact pressure element (2), and the contact pressure element 92) being arranged in the beam path of the laser beam (10),
characterized in that the contact pressure element (2) has an opening (6) which is constructed such that an at least partial passing of the laser beam (10) through the contact pressure element (2) is possible in the direction of the components (3, 4) to be welded, at least in the contact pressure position, and the lateral walls of the opening (6) have a coating (17) which is constructed such that, by means of the laser beam (10), an at least partial chemical or physical conversion of the coating (17) takes place, the conversion being formed such that additional thermal energy is supplied by the conversion.

8. Laser beam welding system according to claim 7,
characterized such that the coating (17) consists of a material absorbing the laser beam (10).

9. Laser beam welding system having a contact pressure device (1) for fixing the components (3, 4) to be welded, the contact pressure device (1) containing a contact pressure element (2) which can be moved from an inoperative position into a contact pressure position, the contact pressure element (2) being constructed to be elastically deformable and the contact pressure device (1) being designed such that, in the contact pressure position, a fixing takes place of the components (3, 4) to be welded by means of a force resulting from a deformation of the contact pressure element (2), furthermore, at least one device (17, 18, 19) being provided for increasing the thermal energy absorbed by the components (3, 4), on the basis of an at least partial absorption of the laser beam (10),
characterized in that the at least one device (17, 18, 19), at least in the contact pressure position, acts at least partially as a beam trap (18) for the laser beam (10) and is constructed such that a concentrated return reflection takes place of the laser radiation of the laser beam (10) reflected by the components (3, 4) back onto the components by means of the at least one device (17, 18, 19), the beam trap (18) being formed by a suitable geometrical construction of the contact pressure element (2).

10. Laser beam welding system according to claim 9,
characterized int hat the beam trap (18) has elements of a concave mirror.

11. Laser beam welding system according to one of claims 9 or 10,
characterized in that the contact pressure element (2) is arranged in the beam path of the laser beam (10) and has an opening (6) which is constructed such that an at least partial passing of the laser beam (10) through the contact pressure element (2) is possible in the direction of the components (3, 4) to be welded at least in the contact pressure position.

12. Laser beam welding system according to one of claims 1 to 11,
characterized in that the contact pressure element (2) is constructed of a flexible plastic material or as a spring element made of metal, particularly as a shaped metal strip which is connected at least at one end, with the contact pressure device (1).

13. Laser beam welding system according to claim 12,
characterized in that the metal strip (2) is constructed to be bent in the shape of a semicircle and is connected with the contact pressure device (1) at both ends.

14. Laser beam welding system according to claim 12 or 13 characterized in that the metal strip (2) consists of tungsten, Cr—Ni steel or spring band steel.

15. Laser beam welding system according to one of claims 1 to 14,
characterized in that a pyrometer (11) is provided for the detection of the thermal radiation emitted by the weld.

16. Laser beam welding system according to claim 15,
characterized in that a dichroitic beam splitter (12) is arranged in the beam path of the laser beam (10), which is constructed such that the thermal radiation emitted by the weld is directed to the pyrometer (11) by the beam splitter (12).

17. Process for the laser beam welding of components, a contact pressure element (2) of a contact pressure device, for fixing the components (3, 4) to be welded, being moved from an inoperative position into a contact pressure position,
characterized in that
an elastically deformable contact pressure element (2) is connected such with the contact pressure device (1) that it is arranged in the beam path of the laser beam (10),
the contact pressure element (2) is moved into the contact pressure position and is held at a defined contact pressure in the contact pressure position,
in the contact pressure position, an opening (6) is placed in the contact pressure element (2) by means of the laser beam (10),
adjacent to the components (3,4), at least one device (17, 18, 19) is arranged for increasing the thermal energy absorbed by the components (3,4), on the basis of an at least partial absorption of the laser beam (10); and
during the welding operation, the contact pressure element (2) is held at the same defined contact pressure for fixing the components (3,4) in the contact pressure position.

18. Process according to claim 17,
characterized in that, during the welding operation, a detection of the thermal radiation of the weld takes place and, as a function thereof, a controlling of the power of the laser beam (10) is carried out.

19. Process according to claim 18,
characterized in that the detection of the thermal radiation takes place coaxially to the beam path of the laser beam (10).
